(19) United States
(12) Patent Application Publication
(10) Pub. No.: US 2006/0082823 A1
(43) Pub. Date: Apr. 20, 2006

(54) Image forming apparatus for periodically cleaning print unit and method thereof

(75) Inventor: Dong-Cheol Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/246,144

(22) Filed: Oct. 11, 2005

(30) Foreign Application Priority Data
Oct. 14, 2004 (KR) 2004-0082188

(51) Int. Cl. G06F 3/12

(52) U.S. Cl. 358/1.15

(57) ABSTRACT

An image forming apparatus periodically cleans print units used for printing. The image forming apparatus comprises a print part that prints by using a replaceable print unit, a memory that stores information regarding a condition for cleaning with respect to the print unit, a status detection part that detects an operational status of the print unit, and a controller that controls the print part to clean the print unit if the operational status detected by the status detection part satisfies the condition for cleaning. The print part supplies a printing paper and transfers a foreign substance left on a surface of the print unit to the printing paper, thereby cleaning the print unit. Accordingly, print quality does not deteriorate.

### CROSS-REFERENCE TO RELATED APPLICATIONS

This application claims the benefit under 35 U.S.C. § 119(a) of Korean Patent Application No. 2004-82188, filed on Oct. 14, 2004, the entire contents of which are hereby incorporated by reference.

### BACKGROUND OF THE INVENTION

1. Field of the Invention

The present invention relates to an image forming apparatus capable of cleaning a print unit inside the image forming apparatus and a method of doing the same. More particularly, the present invention relates to an image forming apparatus which checks an operational status of a print unit, and if a predetermined condition for cleaning is satisfied, cleans off foreign substances left on the print unit by using a cleaning paper, and a method of doing the same.

2. Description of the Related Art

With the development of electronic technology, peripheral devices for computers are increasingly utilized. Since recently developed peripheral devices have both good quality and low cost, the peripheral devices are coming into increasing use in many areas.

An image forming apparatus that produces images using laser printing is one example of a peripheral device. Such laser printing image forming apparatuses include a laser printer, a laser multifunction peripheral device, a photocopier, and a facsimile machine.

FIG. 1 is a view showing a print unit of a conventional image forming apparatus that prints using a laser printing method. Referring to FIG. 1, the print part of the image forming apparatus comprises an organic photoconductor 10, a charging unit 20, a LSU (Laser Scanning Unit) 30, a developing unit 40, a transferring unit 50 and a feeding unit 60.

The charging unit 20 charges a surface of the organic photoconductor 10 with a predetermined polarity. If toner has a negative polarity, the charging unit 20 charges the surface of the organic photoconductor 10 with a negative (−) electric charge by using a charging wire or a rubber roller. Currently, rubber rollers are most frequently used to charge the surface of the organic photoconductor 10. To do so, the rubber roller is brought into contact with the surface of the organic photoconductive cartridge 10 to supply a predetermined range of voltage. Typically, the surface of the organic photoconductor 10 is charged with −600V to −1000V DC.

The LSU 30 performs a writing operation by scanning the surface of the organic photoconductor 10 with laser beams and neutralizing the negative (−) electric charge to thereby form a latent image. The developing unit 40 performs a developing operation by attaching toner to the latent image on the organic photoconductor 10 using a developing roller and converting the latent image into a visible image.

The transferring unit 50 transfers the toner image formed on the surface of the organic photoconductor 10 to a printing side of a printing paper 11. The printing paper 11 is fed by the feeding unit 60. More specifically, the transferring unit 50 supplies a positive (+) high voltage to a transfer roller (not shown) that contacts the backside of the printing paper 11. An electrostatic force is generated due to a corona discharge, and the toner is transferred to the printing paper 11 because the electrostatic force is greater than a force which the toner is subjected to on the organic photoconductor 10.

To prevent malfunctions of the image forming apparatus and maintain normal printing conditions, it is preferable to use new printing paper. However, recycled paper is often used in homes or offices to save costs or for environmental reasons. In this case, the recycled paper may contain foreign substances having an opposite polarity to the toner polarity. For example, if the toner has a negative (−) polarity, foreign substances having a positive (+) polarity such as white clay or tar are more likely to contaminate the surface of the organic photoconductor 10 during the printing process. Therefore, the charging unit 20, the developing unit 40 and the transferring unit 50, which are in close contact with the organic photoconductor 10, are susceptible to the foreign substances.

Especially, when the foreign substances are drawn into toner cartridge in the developing unit 40, they attenuate a negative (−) property of the toner or change it to a positive (+) property. Subsequently, the developing process cannot be performed normally and a thickness of toner layer attached to the latent image becomes thinned, which causes image quality to deteriorate.

Also, external additives such as a charge accelerating agent or wax may be separated from the toner due to the foreign substances. Since the charging process does not operate normally, the surface electric potential of the organic photoconductor 10 is lowered, and thus image quality deteriorates.

Accordingly, there is a need for an laser printing image forming apparatus with improved capabilities for addressing foreign substances on printing paper.

### SUMMARY OF THE INVENTION

An aspect of the present invention is to solve at least the above problems and/or disadvantages and to provide at least the advantages described below. Accordingly, an aspect of the present invention is to provide an image forming apparatus which cleans off drawn-in foreign substances, if a status of a print unit satisfies a predetermined condition for cleaning, and a method thereof.

According to an aspect of the present invention, an image forming apparatus comprises a print part that prints by using a print unit, a memory that stores information regarding a condition for cleaning with respect to the print unit, a status detection part that detects status information corresponding to an operational status of the print unit, and a controller that controls the print part to clean the print unit if the status information detected by the status detection part satisfies the condition for cleaning.

The memory may be a cartridge memory that is provided in a cartridge of the print unit.

The print part supplies printing paper and transfers a foreign substance on a surface of the print unit to the printing paper according to the control of the controller, thereby cleaning the print unit.

The status detection part counts at least one of a number of printed copies output from the print part, a number of printing dots, or a driving time of the print unit.

The controller stores the status information detected by the operational status detector in the memory every time that a printing job is completed.

The memory stores a reference value about at least one of the number of printed copies, the number of printing dots, or the driving time as the condition for cleaning. The controller determines that the condition for cleaning is satisfied if a value obtained by adding the status information detected by the status detection part to status information previously stored in the memory exceeds the reference value.

The print part may comprise an organic photoconductor, a charging unit for charging a surface of the organic photoconductor with a predetermined polarity, a laser scanning unit (LSU) for scanning the charged surface of the organic photoconductor with a laser signal, a developing unit for attaching toner of a predetermined polarity to a latent image formed by the laser signal, a feeding unit for feeding printing paper, a transferring unit for transferring toner attached to the surface of the organic photoconductor, and a print unit driver for supplying a driving voltage of a predetermined magnitude to the charging unit, the LSU, the developing unit, the feeding unit and the transferring unit.

The print unit driver powers-off the charging unit, the LSU, and the developing unit, feeds a cleaning paper by using the feeding unit, and changes a polarity of the driving voltage supplied to the transferring unit, thereby transferring a foreign substance having a polarity opposite to a polarity of the toner to the cleaning paper.

A method for cleaning an image forming apparatus which performs a printing job by using a print unit comprises the steps of (a) detecting status information corresponding to an operational status of the print unit, (b) reading out information regarding a condition for cleaning with respect to the print unit from a memory, (c) determining whether the status information regarding the print unit satisfies the condition for cleaning, and (d) cleaning the print unit if the condition for cleaning is satisfied.

The memory may be a cartridge memory that is provided in a cartridge of the print unit.

The step of (d) may comprise feeding a predetermined cleaning paper and transferring a foreign substance left on a surface of the print unit to the cleaning paper.

The step of (a) may comprise counting at least one of a number of printed copies, a number of printing dots, or a driving time of the print unit, and outputting the counted values as the status information.

The method may further comprise the step of storing the counted status information in the memory every time that a printing job is completed.

The method may further comprise the step of storing in the cartridge memory a reference value which is set with respect to at least one of the number of printed copies, the number of printing dots, or the driving time, as the condition for cleaning. The step of (c) may comprise determining that the condition for cleaning is satisfied if a value obtained by adding the counted status information to status information previously stored in the memory exceeds the reference value.

The print unit may be at least one of an organic photoconductor, a charging unit, a transferring unit, or a developing unit.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a view of a print part of a general laser printer;

FIG. 2 is a block diagram of an image forming apparatus according to an exemplary embodiment of the present invention;

FIG. 3 is a view of a print part used in the image forming apparatus of FIG. 2;

FIG. 4 is a view explaining a cleaning operation of the image forming apparatus of FIG. 2; and

FIG. 5 is a flowchart showing a cleaning method according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

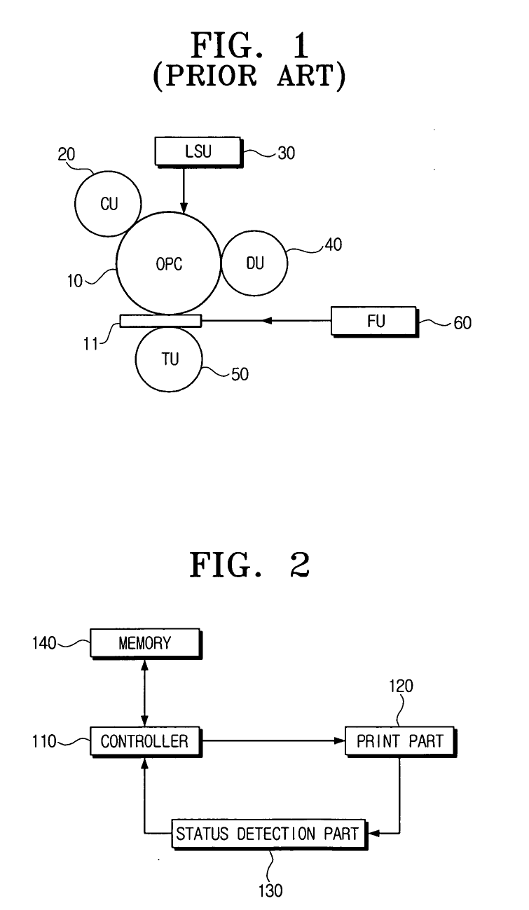

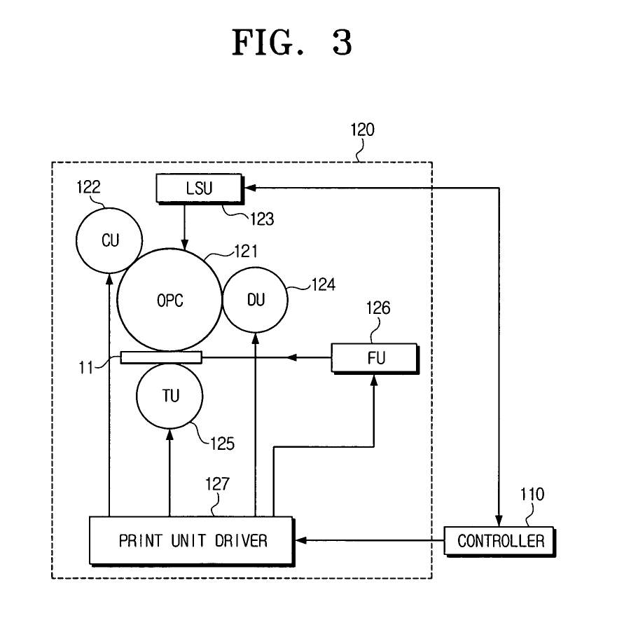

FIG. 2 is a block diagram showing an image forming apparatus according to an exemplary embodiment of the present invention. Referring to FIG. 2, the image forming apparatus comprises a controller 110, a print part 120, a status detection part 130, and a memory 140.

The print part 120 prints predetermined print data on paper using internal printing components. The structure and operation of the print part 120 will be described in further detail below.

The status detection part 130 detects an operational status of the print part 120 in various manners. For example, the status detection part 130 detects the number of printed copies that are output from the print part 120, the number of dots necessary to print predetermined print data at the print part 120, or the driving time of the print part 120.

More specifically, the number of printed copies is obtained based on the number of turns of a feeding roller (not shown), and the number of printing dots is obtained based on the number of single bit data input in the form of a digital signal. The driving time of the print unit 120 is obtained by counting the time from when the print unit 120 is driven until the operation of the print unit 120 finishes. The driving time of the print unit 120 may be counted by a timer.

The memory 140 stores information regarding a predetermined condition for cleaning with respect to the status of the print part 120. A manufacturer or user of the image forming apparatus sets a reference value with respect to the number of printed copies, the number of printing dots, or the driving time, and stores the reference value in the memory 140 as the information regarding the condition for cleaning.

In this case, the memory 140 may be a cartridge memory provided in the print part 120. The print part 120 may be an integral type unit or a separable type unit. In the integral type unit, the internal print components are integrated into a single body, and in the separable type unit, the internal print components are individually replaceable. More specifically, in the integral type unit, a charging unit, a developing unit, and an organic photoconductor are integrated into a single cartridge and the integrated cartridge is mounted in a body of the image forming apparatus. In this case, a memory (that is, the cartridge memory) is also provided in the integrated cartridge to record the information regarding the condition for cleaning. Since the number of printed copies, the number of printing dots, or the driving time is recorded on the cartridge memory, even if the cartridge is separated and mounted in another image forming apparatus, a user always knows the status of the cartridge.

In the separable type unit, a charging unit, a developing unit, and an organic photoconductor are provided in separate cartridges and mounted in the image forming apparatus. Like the integral type, an extra memory is provided in a cartridge of each unit, so that information regarding the condition for cleaning and status information regarding the print unit can be recorded.

If the operational status of the print part 120 is detected by the status detection part 130, the controller 110 determines whether the detected status satisfies the condition for cleaning which is stored in the memory 140. More specifically, the controller 110 determines whether the number of printed copies, the number of printing dots, or the driving time is greater than or equal to a reference value which has been set with respect to the number of printed copies, the number of printing dots, or the driving time, and, if so, determines that the condition for cleaning is satisfied.

If the controller 110 determines that the condition for cleaning is satisfied, it controls the print part 120 to clean the print units. Accordingly, the print part 120 feeds a cleaning paper and transfers foreign substances left on the respective print units to the cleaning paper, thereby removing the foreign substances.

FIG. 3 is a view showing the print part 120 used in the image forming apparatus according to an exemplary embodiment of the present invention. Referring to FIG. 3, the print part 120 comprises an organic photoconductor 121, a charging unit 122, a laser scanning unit (LSU) 123, a developing unit 124, a transferring unit 125, a feeding unit 126 and a print unit driver 127.

The operation of the organic photoconductor 121, the charging unit 122, the LSU 124, developing unit 124, the transferring unit 125, and the feeding unit 125 is substantially identical to those of a conventional image forming apparatus, and thus a detailed description will be omitted for brevity.

The print unit driver 127 supplies a driving power to drive the respective print units, that is, the charging unit 122, the LSU 123, the developing unit 124, the transferring unit 125 and the feeding unit 126.

The print unit driver 127 performs a cleaning operation on receipt of a predetermined control signal to clean the print units from the controller 110. First, the print unit driver 127 supplies a driving power to the feeding unit 126 so that the feeding unit 126 feeds a printing paper 11 for cleaning (that is, a cleaning paper). In the meantime, the print unit driver 127 stops supplying driving power to the charging unit 122 and the developing unit 124, and supplies the transferring unit 125 with a transfer voltage having an opposite polarity to the polarity of the current transfer voltage. For example, if the toner has a negative (−) polarity, a negative (−) transfer voltage is supplied so that the backside of the cleaning paper 11 which contacts the surface of the organic photoconductor 121 is charged with a negative (−) charge. Consequently, a foreign substance of a positive (+) polarity, which is adhered to the surface of the organic photoconductor 121, is transferred to the cleaning paper 11. If foreign substances are adhered to a charging roller (not shown) or a developing roller (not shown) used in the charging unit 122 and the developing unit 124, they are transferred to the surface of the organic photoconductor 121 and then to the cleaning paper 11 during this process.

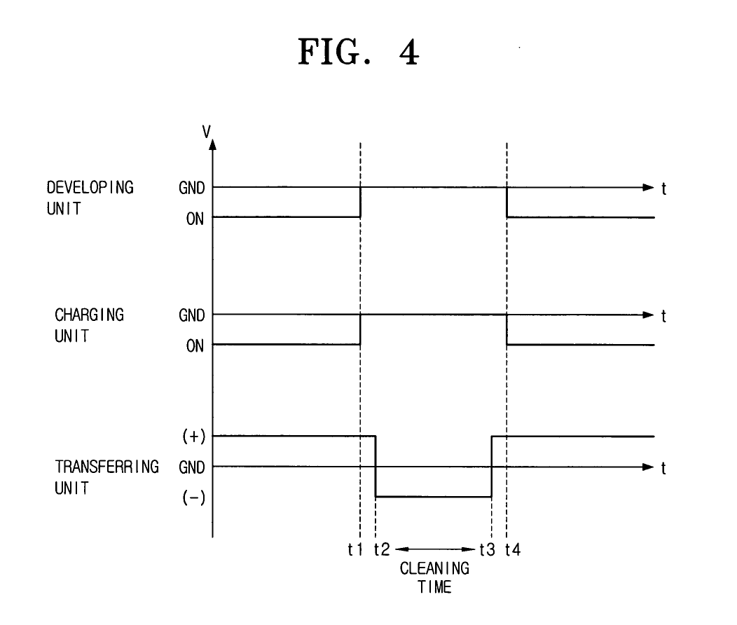

FIG. 4 is a view showing the time frame for controlling the driving power supplied to the respective print units from the print unit driver 127. Referring to FIG. 4, a negative (−) driving power is supplied to the developing unit 124 and the charging unit 122 from time 0 to time t1, and simultaneously, a positive (+) transfer voltage is supplied to the transferring unit 125, to perform a normal printing operation.

At the time t1, if the print unit driver 127 receives a cleaning command from the controller 110, it turns off the developing unit 124 and the charging unit 122 to stop their operations, and then supplies a negative (−) transfer voltage to the transferring unit 125. Although the transfer voltage is supplied to the transferring unit 125 at the same time as when the developing unit 124 and the charging unit 122 are tuned off, the transfer voltage may be supplied at the time t2 when a predetermined time lapses from t1 for a more stable operation.

Accordingly, the cleaning operation is performed by the negative (−) transfer voltage from the time t2 to time t3. When it is determined that the foreign substance is sufficiently removed at the time t3, a positive (+) transfer voltage is again supplied to the transferring unit 125 and a driving power is supplied to the developing unit 124 and the charging unit 122, thereby performing a normal printing operation. In this case, the driving force may be supplied to the developing unit 124 and the charging unit 122 at the time t4 when a predetermined time lapses from t3.

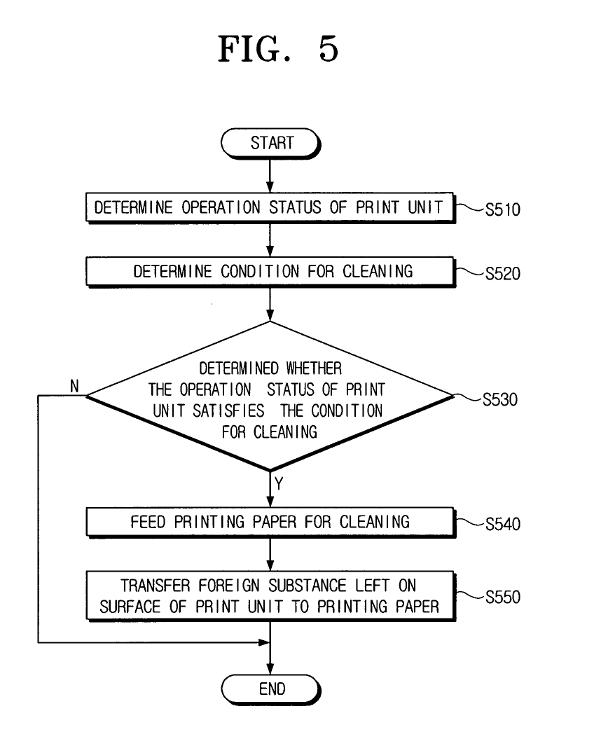

FIG. 5 is a flowchart showing a cleaning method of the image forming apparatus according to an exemplary embodiment. Referring to FIG. 5, an operational status of print units used in the print part is determined at step S510. The operational status of the print units is determined by counting the number of printed copies, the number of printing dots, or the driving time of the print units.

Meanwhile, the controller 100 reads out information regarding a condition for cleaning from the memory 140 at step S520, and determines whether the operational status of the print units satisfies the condition for cleaning at step S530. In this case, the information regarding the condition for cleaning is a reference value that has been previously set with respect to the number of printed copies, the number of printing dots, or the driving time of the print units.

As described above, the memory 140 uses a cartridge memory provided in a cartridge of the print units.

If the condition for cleaning is set to the number of printed copies=α, and the number of printed copies, which is currently output from the print units, is greater than or equal to α, it is determined the cleaning condition is satisfied. Similarly, if the condition for cleaning is set to the number of printing dots=β, or the driving time=γ, and the number of printing dots is greater than or equal to β, or the driving time is greater than or equal to γ, it is determined that the condition for cleaning is satisfied.

If it is determined that the cleaning condition is satisfied, a printing paper for cleaning (a cleaning paper) is supplied at step S540 and any foreign substance is transferred from the surfaces of the print units to the cleaning paper, so that a cleaning operation is performed at step S550. The cleaning operation is periodically performed with respect to the print units, such as the developing unit 124, the charging unit 122, the transferring unit 125, and the organic photoconductor 121, used in the image forming apparatus.

As described above, according to the present invention, a drawn-in foreign substance is removed by using the printing paper so that the respective print units used in the image forming apparatus can be cleaned periodically. Therefore, the lifespan of each print unit can extend. Also, since changes in the toner characteristics due to the foreign substances can be prevented, and the problem of the deterioration of the print quality is mitigated. Since the print unit has a cartridge memory in its own cartridge, for determining whether to clean the print unit, a cleaning cycle is accurately determined even if the print unit is mounted in another image forming apparatus.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming apparatus comprising:
a print part that prints by using a print unit;
a memory that stores information regarding a condition for cleaning with respect to the print unit;
a status detection part that detects status information corresponding to an operational status of the print unit; and
a controller that controls the print part to clean the print unit if the status information detected by the status detection part satisfies the condition for cleaning.

2. The image forming apparatus as claimed in claim 1, wherein
the memory is a cartridge memory that is provided in a cartridge of the print unit.

3. The image forming apparatus as claimed in claim 2, wherein
the print part supplies printing paper and transfers a foreign substance left on a surface of the print unit to the printing paper according to a control of the controller, thereby cleaning the print unit.

4. The image forming apparatus as claimed in claim 3, wherein
the status detection part counts at least one of a number of printed copies output from the print part, a number of printing dots, or a driving time of the print unit, and outputs the counted value as the status information.

5. The image forming apparatus as claimed in claim 4, wherein
the controller stores the status information detected by the operational status detector in the memory every time that a printing job is completed.

6. The image forming apparatus as claimed in claim 5, wherein
the memory stores a reference value about at least one of the number of printed copies, the number of printing dots, or the driving time as the condition for cleaning.

7. The image forming apparatus as claimed in claim 6, wherein
the controller determines that the condition for cleaning is satisfied if a value obtained by adding the status information detected by the status detection part to status information previously stored in the memory exceeds the reference value.

8. The image forming apparatus as claimed in claim 1, wherein the print part comprises:
an organic photoconductor;
a charging unit for charging a surface of the organic photoconductor with a predetermine polarity;
a laser scanning unit for scanning the charged surface of the organic photoconductor with a laser signal;
a developing unit for attaching toner of a predetermined polarity to a latent image formed by the laser signal;
a feeding unit for feeding a printing paper;
a transferring unit for transferring the toner attached to the surface of the organic photoconductor to the printing paper; and
a print unit driver for supplying a driving voltage of a predetermined magnitude to the charging unit, the laser scanning unit, the developing unit, the feeding unit and the transferring unit.

9. The image forming apparatus as claimed in claim 8, wherein
the print unit driver powers-off the charging unit, the laser scanning unit, and the developing unit, feeds a cleaning paper by using the feeding unit, and changes a polarity of the driving voltage supplied to the transferring unit, thereby transferring a foreign substance having a polarity opposite to a polarity of the toner to the cleaning paper.

10. The image forming apparatus as claimed in claim 9, wherein
the print unit is at least one of the organic photoconductor, the charging unit, the transferring unit, or the developing unit.

11. A method for cleaning an image forming apparatus which prints by using a print unit, the method comprising the steps of:
(a) detecting status information corresponding to an operational status of the print unit;
(b) reading information regarding a condition for cleaning with respect to the print unit from a memory;
(c) determining whether the status information regarding the print unit satisfies the condition for cleaning; and
(d) cleaning the print unit if the condition for cleaning is satisfied.

12. The method as claimed in claim 11, wherein
the memory is a cartridge memory that is provided in a cartridge of the print unit.

13. The method as claimed in claim 12, wherein
the step of (d) comprises feeding a predetermined cleaning paper and transferring a foreign substance left on a surface of the print unit to the cleaning paper.

14. The method as claimed in claim 13, wherein
the step of (a) comprises counting at least one of a number of printed copies, a number of printing dots, or a driving time of the print unit, and outputting the counted values as the status information.

15. The method as claimed in claim 14, further comprising the step of:
storing the counted status information in the memory every time that a printing job is completed.

16. The method as claimed in claim 15, further comprising the step of:
storing in the cartridge memory a reference value which is set with respect to at least one of the number of printed copies, the number of printing dots, or the diving time, as the condition for cleaning.

17. The method as claimed in claim 16, wherein
the step of (c) comprises determining that the condition for cleaning is satisfied if a value obtained by adding the counted status information to status information previously stored in the memory exceeds the reference value.

18. The method as claimed in claim 11, wherein
the print unit is at least one of an organic photoconductor, a charging unit, a transferring unit, or a developing unit.
